(19) United States
(12) Patent Application Publication
(10) Pub. No.: US 2021/0223432 A1
(43) Pub. Date: Jul. 22, 2021

(54) WEATHER REMINDER APPARATUS

(71) Applicant: Kai-Chih Hu, Taipei City (TW)

(72) Inventor: Kai-Chih Hu, Taipei City (TW)

(21) Appl. No.: 16/747,611

(22) Filed: Jan. 21, 2020

(51) Int. Cl. G01W 1/10; G01W 1/02; G01W 1/16; A45B 9/02; A45B 3/04; A45B 25/00; H04W 4/80

(52) U.S. Cl. CPC G01W 1/10; G01W 1/02; G01W 1/16; A45B 9/02; A45B 2025/003; A45B 25/00; H04W 4/80; A45B 2200/1081; A45B 3/04

(57) ABSTRACT

A weather reminding apparatus is provided, including: an application program, a main body, a communication module, a processing module, and a display module. The application program is installed on a mobile communication device, the main body is mounted on an umbrella grip, the communication module, processing module, and display module are disposed at the main body. The mobile communication device receives weather forecast data for one to several hours from a cloud server for the area where the mobile communication device is located, and the application generates a weather reminder command based on the weather forecast data. The communication module can wirelessly connect the mobile communication device and receive the weather reminder command. The processing module controls the display module to display a weather reminder signal in response to the weather reminder command.

### BACKGROUND OF THE INVENTION

### 1. Field of the Invention

The present invention relates generally to a reminder apparatus, and more particularly, to provide a weather reminder apparatus applicable to umbrellas.

### 2. The Prior Arts

Umbrellas are everyday appliances for blocking sun or rain. A common experience for most people is to forget taking the umbrella when the weather changes. With the advancement of communication technology, an umbrella equipped with a sensor module in the grip able to wirelessly connect to a mobile phone is now available, and the mobile phone uses an application program corresponding to the sensor module. When the distance between user's mobile phone and the umbrella exceeds a preset distance, the application generates a signal to remind the user not to forget to take the umbrella.

In the aforementioned umbrella with a reminder function, the application generates a signal according to the distance between the mobile phone and the umbrella, instead of whether the umbrella is needed. The application generates a signal to alert the user only when the user is separated from the umbrella at a distance exceeding a preset distance threshold. If the user needs to be separated from the umbrella for a period of time, the user must turn off the application. Therefore, in the prior art, the reminder function to take an umbrella is not practically achieved. The main object of developing the present invention is to use information technology to solve various problems in umbrella usage.

### SUMMARY OF THE INVENTION

To achieve the above objective, the present invention provides a weather reminder apparatus, comprising: an application program, a main body, a communication module, a processing module, and a display module; the application program being loaded on a mobile communication device, the main body being installed on an umbrella grip, and the communication module, processing module and display module being disposed on the main body; the mobile communication device receives weather forecast data for one to several hours for the area where the mobile communication device being located from a cloud server, and the application generating a weather reminder command based on the weather forecast data; the communication module being wirelessly connected to the mobile communication device and receiving the weather reminder command; the processing module controlling the display module to display a weather reminder signal in response to the weather reminder command.

In an embodiment, the weather forecast data comprises a probability of precipitation, and the application program is provided with a first threshold and a second threshold; when the probability of precipitation is not lower than the first threshold, the application program generates the weather reminder command corresponding to a rainy day; when the probability of precipitation is not higher than the second threshold, the application program generates the weather reminder command corresponding to a clear day; when the probability of precipitation is between the first threshold and the second threshold, the application program generates the weather reminder command corresponding to a cloudy day.

In an embodiment, the weather forecast data further comprises a snowfall probability, and the application program is provided with a snow threshold; when the snowfall probability is not lower than the snow threshold, the application program generates the weather reminder command corresponding to a snowy day.

In an embodiment, the main body is detachably mounted on the umbrella grip by means of screwing, hanging or fitting.

In an embodiment, the communication module transmits identification data of the Bluetooth low energy (BLE) protocol to connect to the mobile communication device; after the mobile communication device receives the identification data, the application program transmits the weather reminder command of Bluetooth low energy protocol to the communication module.

In an embodiment, the display module comprises a light-emitting diode unit and a power unit.

In an embodiment, the power unit comprises a charging port, providing connection to an external power source for charging.

In an embodiment, the weather reminder signals comprise optical signals corresponding to rainy, sunny, and cloudy days.

In the weather reminder apparatus of the present invention, a communication module, a processing module and a display module are disposed on a main body, and the main body is installed on an umbrella grip; in addition, an application program is installed on the user's mobile communication device. When the mobile communication device is connected to the communication module, the application program can receive weather forecast data to generate a weather reminder command. The mobile communication device transmits the weather reminder command to the communication module. The processing module controls the display module to display a weather reminder signal in response to the weather reminder command. The users can find their own umbrellas by looking at the umbrella grip, and decide whether to bring an umbrella without having to check the weather, to solve the problems of the prior art, to achieve the reminder and to facilitate the convenience of using the umbrella.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram of a weather reminder apparatus according to an embodiment of the present invention;

FIG. 2 is a flowchart of steps for generating a weather reminder command by the weather reminder apparatus of the present invention; and

FIG. 3 is a schematic view of a weather reminder apparatus according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

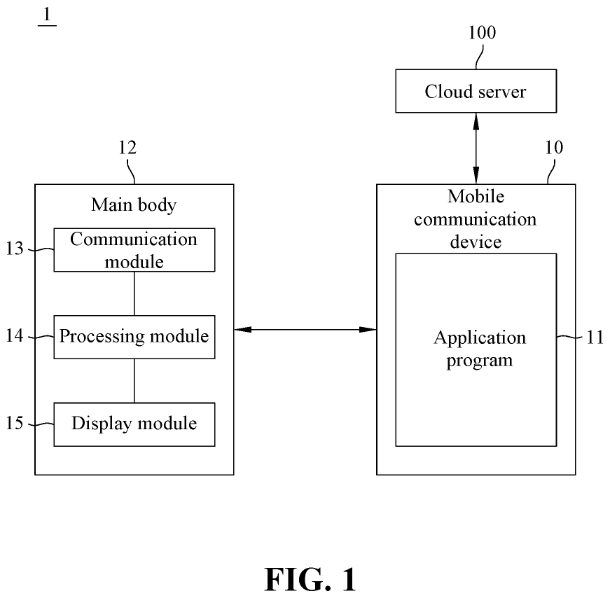

FIG. 1 is a block diagram of a weather reminder apparatus according to an embodiment of the present invention. As shown in FIG. 1, the weather reminder apparatus 1 comprises: an application program 11 installed on a mobile communication device 10, a main body 12 installed on an umbrella grip (not shown), and a communication module 13, a processing module 14 and a display module 15, all provided on the main body 12.

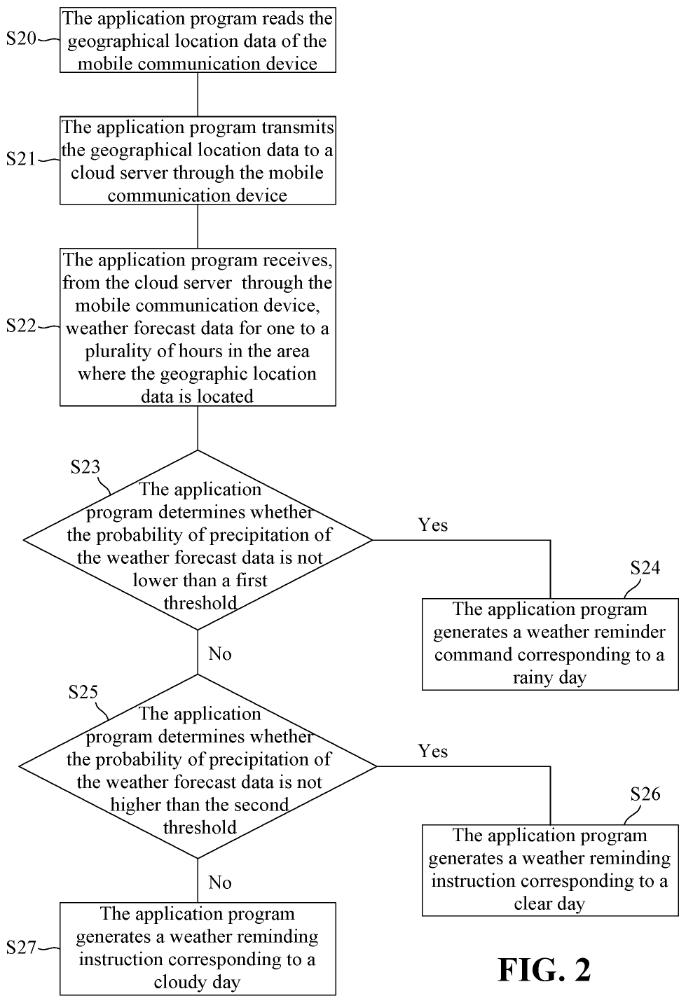

FIG. 2 is a flowchart of steps for the weather reminder apparatus of the present invention to generate a weather reminder command. As shown in FIGS. 1 and 2, in step S20, the application program 11 reads the geographical location data of the mobile communication device 10; in step S21, the application program 11 transmits the geographical location data to a cloud server 100 through the mobile communication device 10; step S22, the application program 11 receives, from the cloud server 100 through the mobile communication device 10, weather forecast data for one to a plurality of hours in the area where the geographic location data is located; in step S23, the application program 11 determines whether the probability of precipitation of the weather forecast data is not lower than a first threshold; if yes, go to step S24, the application program 11 generates a weather reminder command corresponding to a rainy day; if no, go to step S25, the application program 11 determines whether the probability of precipitation of the weather forecast data is not higher than the second threshold, if yes, go to step S26, the application program 11 generates a weather reminding instruction corresponding to a clear day; otherwise, go to step S27, the application program 11 generates a weather reminding instruction corresponding to a cloudy day.

The mobile communication device 10 is, for example, a smart phone, a tablet, a notebook computer, a smart bracelet, etc., and the user can download the application program 11 from an application network platform. The existing mobile communication device 10 already has a satellite positioning function. Therefore, in step S20, the user can set the timing of the application program 11 (tens of minutes to hours, such as, but not limited to, 30 minutes, 1 hour, 2 hours, 3 hours or more) to automatically retrieve the geographic location data of the mobile communication device 10; in step S21, the application program 11 transmits the geographic location data to a cloud server through the Internet according to a preset or user-set cloud server URL that provides weather forecasts. In step S22, the cloud server 100 transmits the real-time weather and weather forecast data of the area where the mobile communication device 10 is located to the mobile communication device 10 according to the received geographic location data.

In step S23, the weather forecast data comprises the probability of precipitation over a period of time (for example, one hour or until tomorrow). The user can set the time range and at least one threshold of the weather forecast data used by the application program 11. The weather forecast data, for example, within 1 to 12 hours; the thresholds comprise the first threshold and the second threshold, wherein the first threshold may be 60%, 70%, 80%, 90% or more, and the second threshold may be 50%, 40%, 30%, 20%, 10% or lower. The application program 11 first determines whether the probability of precipitation in the set time range is not lower than the first threshold (for example: 70%). The application program 11 proceeds to step S24 to generate a weather reminder command corresponding to a rainy day. When the application program 11 determines that the probability of precipitation of the weather forecast data is lower than the first threshold, the application program 11 proceeds to step S25 and then determines whether the probability of precipitation of the weather forecast data is not higher than the second threshold (for example: 50%). If the result judgment is yes, the application program 11 proceeds to step S26 to generate a weather reminder command corresponding to a clear day; when the application program 11 determines the probability of precipitation is between the first threshold and the second threshold (for example, 51-69%), the application program 11 proceeds to step S27 to generate a weather reminder command corresponding to a cloudy day.

In another embodiment, the weather forecast data may further comprise a snowfall probability, and the user may set a snowfall threshold of the application program 11 for determining a snowy day (for example, 50% or more). When the weather forecast data comprises the snowfall probability, the application program 11 determines whether the snowfall probability of the weather forecast data is not lower than the snowfall threshold of a snowy day, if yes, the application program 11 generates a weather reminder command corresponding to a snowy day.

The shape of the main body 12 may correspond to the grip shape of various umbrellas, such as, but not limited to, a cylindrical shape or a polygonal cylindrical shape. The main body 12 is detachably mounted on the umbrella grip by means of screwing, hanging or fitting, so that the user can install the main body 12 on the umbrella grip by themselves.

The communication module 13 is, for example, but not limited to, a Bluetooth Low Energy (BLE) communication module, which can broadcast a packet of identification data containing a Received Signal Strength Indicator (RSSI) within a radius of tens of centimeters to tens of meters at a frequency of seconds to tens of seconds. When using the weather reminder apparatus 1 for the first time, the user must turn on the Bluetooth communication function of the application program 11 and the mobile communication device 10 to pair the mobile communication device 10 to the communication module 13.

The processing module 14 comprises a memory and a logic circuit, and the memory stores control instructions corresponding to each weather reminder command. The logic circuit generates a control instruction according to the weather reminder command received by the communication module 13 to control the display module 15 to generate a weather reminder signal.

In an embodiment, when the mobile communication device 10 enters the broadcast range of the communication module 13 and receives the identification data, the user does not need to manually start the application program 11. The application program 11 can receive the weather forecast data to generate a specific weather reminder command, and the weather reminder command is transmitted in real-time to the communication module 13. The processing module 14 receives weather reminder command from the communication module 13, and generates a specific control instruction corresponding to the weather reminder command; and the display module 15 receives the control instruction to display the corresponding weather reminder signal to remind users of the weather condition.

In another embodiment, the user can start the application program 11 to actively search for and connect the paired communication module 13. On one hand, the application program 11 can calculate distance between the mobile communication device 10 and the communication module 13 (equivalent to the user and the umbrella) according to the received signal strength indication of the identification data packet. On the other hand, the application program 11 transmits a specific weather reminder command to the communication module 13, and the processing module 14 receives the weather reminder command from the communication module 13, and a specific control instruction is generated corresponding to the weather reminder instruction; the display module 15 receives the control instruction to display the weather reminder signal; thereby, the user can know the distance or location of the umbrella. It is worth noting that the mode of the application program 11 to remind of the distance of the umbrella can be set by the user to generate a weather reminder command upon leaving or entering the communication range of the communication module 13.

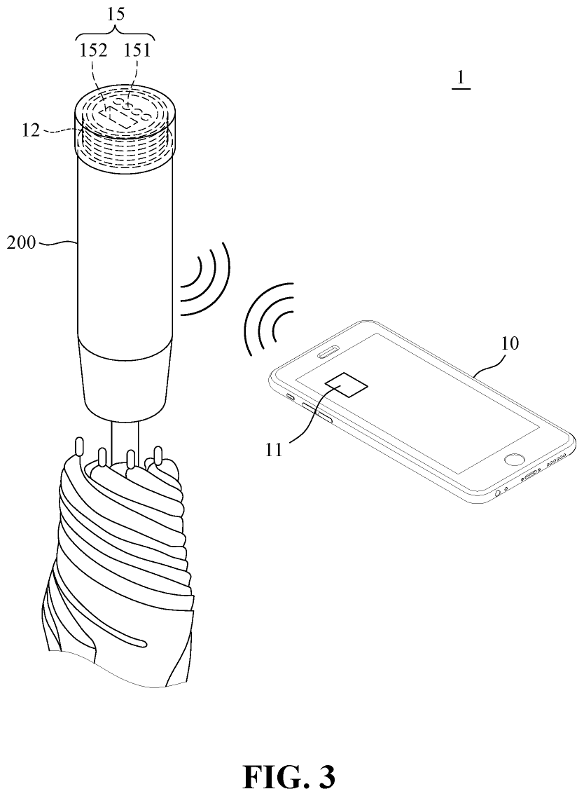

FIG. 3 is a schematic view of a weather reminder apparatus according to an embodiment of the present invention. As shown in FIG. 3, the communication module and the processing module (not shown) are disposed inside the main body 12, and the display module 15 is disposed on one side of the main body 12. The main body 12 is installed on the umbrella grip 200, and the application program 11 and the communication module (not shown) in the main body 12 has been successfully paired. In this embodiment, the display module 15 comprises a light-emitting diode unit 151 and a power unit. The light-emitting diode unit 151 comprises light-emitting diodes of different light colors. The power unit is, for example, a replaceable primary battery or comprises a lithium battery with a charging port 152. The charging port 152 can be connected to an external power source to charge the secondary lithium battery.

When the user's mobile communication device 10 is connected to the communication module 13, the application 11 receives the weather forecast data to generate a weather reminder command. The mobile communication device 10 transmits the weather reminder command to the communication module 13, and the processing module 14 generates the control instruction corresponding to the weather reminder command to control the display module 15 to display optical signals of different colors. For example: a red light indicates that the probability of precipitation is not less than 70%, a yellow light indicates that the probability of precipitation is between 51 and 69%, and a green light indicates that the probability of precipitation is not higher than 50%. The user can decide whether to bring an umbrella by looking at the weather reminder signal.

In another embodiment, in addition to a weather reminder signal displayed the display module 15 installed on the umbrella grip 200, the application program 11 can use sounds or graphics SMS to remind users to pay attention to weather conditions and whether to bring an umbrella when the mobile communication device 10 is connected to the communication module 13.

In the weather reminding apparatus of the present invention, a communication module, a processing module and a display module are disposed on a main body, and the main body is installed on an umbrella grip; in addition, an application program is installed on the user's mobile communication device. When the mobile communication device is connected to the communication module, the application program can receive weather forecast data to generate a weather reminder command. The mobile communication device transmits the weather reminder command to the communication module. The processing module controls the display module to display a weather reminder signal in response to the weather reminder command. The users can find their own umbrellas by looking at the umbrella grip, and decide whether to bring an umbrella without having to check the weather, to solve the problems of the prior art, to achieve the reminder and to facilitate the convenience of using the umbrella.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A weather reminder apparatus, comprising:
an application program, installed on a mobile communication device, having a first threshold and a second threshold, wherein the mobile communication device receiving weather forecast data comprising probability of precipitation for one to several hours from a cloud server for the region where the mobile communication device being located, and the application program generating a weather reminder command based on the weather forecast data; when the probability of precipitation not lower than the first threshold, the application program generating the weather reminder command corresponding to a rainy day, when the probability of precipitation not higher than the second threshold, the application program generating the weather reminder command corresponding to a clear day, when the rainfall probability is between the first threshold and the second threshold, the application program generating the weather reminder command corresponding to a cloudy day; and
a main body, a communication module, a processing module, and a display module; the main body being installed on an umbrella grip by screwing, hanging or fitting; the communication module, processing module and display module being disposed on the main body; wherein the communication module being wirelessly connected to the mobile communication device and receiving the weather reminder command; the processing module controlling the display module to display a weather reminder signal in response to the weather reminder command.

2. The weather reminder apparatus according to claim 1, wherein the weather forecast data further comprises a snowfall probability, and the application program is provided with a snow threshold; when the snowfall probability is not lower than the snow threshold, the application program generates the weather reminder command corresponding to a snowy day.

3. The weather reminder apparatus according to claim 1, wherein the communication module transmits identification data of the Bluetooth Low Energy (BLE) protocol to connect to the mobile communication device; after the mobile communication device receives the identification data, the application program transmits the weather reminder command of Bluetooth low energy protocol to the communication module.

4. The weather reminder apparatus according to claim 1, wherein the display module comprises a light-emitting diode unit and a power unit.

5. The weather reminder apparatus according to claim 4, wherein the power unit comprises a charging port, providing connection to an external power source for charging.

6. The weather reminder apparatus according to claim 1, wherein the weather reminder signals comprise optical signals corresponding to rainy, sunny, and cloudy days.
